(19) United States
(12) Patent Application Publication
(10) Pub. No.: US 2007/0201222 A1
(43) Pub. Date: Aug. 30, 2007

(54) Tool hand tube rod

(76) Inventor: Chih-Ching Hsieh, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/352,282

(22) Filed: Feb. 13, 2006

(51) Int. Cl. B25B 23/18; B25B 23/14

(52) U.S. Cl. 362/119; 73/862.23; 81/467

(57) ABSTRACT

A tool hand tube rod which comprises a long hollow rod body; having a receiving space; a lateral side of the rod body having an open hole; and one end of the rod body having a inserting end; a driving head inserted into the inserting end of the rod body; a strain gauge installed within the receiving space near the inserting end; a processing unit installed in the receiving space; and a display protruded from the open hole. A strain force of the driving head can be measured by the strain gauge; then the measured value is transferred to the processing unit and then is displayed on the display. Or a lamp installed in the open hole and a switch installed below the lamp body. Or a plurality of driving heads are received in the receiving space.

### FIELD OF THE INVENTION

The present invention relates to hand tools, and particularly to a tool hand tube rod, wherein the rod body is made by punching a metal sheet. The toolbox has a receiving space, an inserting end; and an open hole for installing some elements so as to form a hand tool.

### BACKGROUND OF THE INVENTION

In the prior art the hand tool has a rod body and one or two ends of the rod body are installed with driving heads. The driving head can be used to drive a screw unit so as to drive the screw element. However the prior art is fixed driving head and the function of the hand tool is confined. Thereby the prior art is not suitable for many operations in different conditions.

To improve the defects in the prior art, one prior art, Taiwan Patent No. 569874, discloses an electronic strain gauge. A metal solid rod body is made by forging or molding. Then the rod body is formed with holes for receiving the elements, such as strain gauges, lamps, or other auxiliary tools. Thereby there are two processes being used, one is to form the solid metal rod body and the other is to form holes for receiving elements. The process is tedious and uneconomic. Thus the cost is high and is not a marketable merchandise.

Thereby there is an eager demand for a tool hand tube rod which can be made easily and can install other parts conveniently for forming a useful hand tool.

### SUMMARY OF THE INVENTION

Accordingly, the primary object of the present invention is to provide a tool hand tube rod, wherein the rod body is made by punching a metal sheet. The toolbox has a receiving space, an inserting end; and an open hole for installing some elements so as to form a hand tool.

To achieve above objects, the present invention provides a tool hand tube rod which comprises a long hollow rod body; having a receiving space; a lateral side of the rod body having an open hole; and one end of the rod body having an inserting end; a driving head inserted into the inserting end of the rod body; a strain gauge installed within the receiving space near the inserting end; a processing unit installed in the receiving space; a display protruded from the open hole. A strain force of the driving head can be measured by the strain gauge; then the measured value is transferred to the processing unit and then is displayed on the display.

Furthermore, the present invention provide a tool hand tube rod which comprises a long hollow rod body; having a receiving space; a lateral side of the rod body having an open hole; and one end of the rod body having a inserting end; a lamp installed in the open hole and a switch installed below the lamp body.

Furthermore, the present invention provide a tool hand tube rod which comprises a long hollow rod body; having a receiving space; a lateral side of the rod body having an open hole; and one end of the rod body having a inserting end; and a plurality of driving heads are received in the receiving space.

The various objects and advantages of the present invention will be more readily understood from the following detailed description when read in conjunction with the appended drawing.

### BRIEF DESCRIPTION OF THE DRAWINGS

FIGS. 1-1, 1-2, 1-3, and 1-4 are schematic views about the forming process of the tool hand tube rod of the present invention.

FIG. 2 is a schematic perspective view about the tool hand tube rod of the present invention.

FIGS. 3 and 4 show the first embodiment of the present invention.

FIGS. 5 and 6 show the second embodiment of the present invention.

FIGS. 7 to 10 show the third embodiment of the present invention.

FIGS. 11 and 12 shows the fourth embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

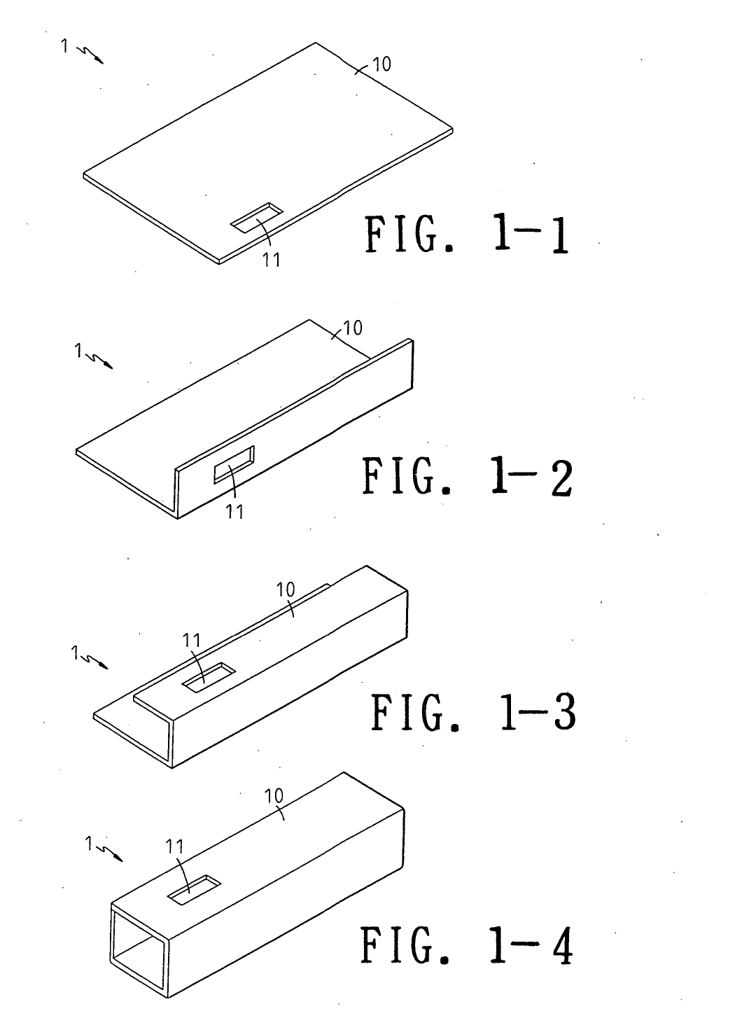

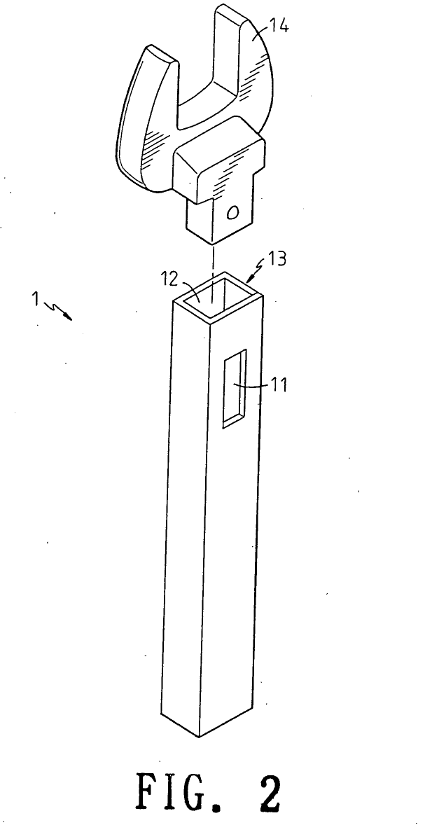

Referring to FIGS. 1 to 2, the present invention has the following elements.

A long hollow rod body 1 is made by punching a metal sheet 10.

Referring to FIGS. 1 to 4, the forming of the rod body 1 is illustrated.

The forming process comprises the steps of: forming a metal sheet 10 with a predetermined width and strength; punching an open hole 11 on the sheet 10, punching the sheet 10 three times so that the sheet 10 is formed as a tube which is as the rod body 1. An inner side of the rod body 1 is formed as a receiving space 12. One end of the rod body 1 is formed as an inserting end 13.

The open hole 11 and the receiving space 12 are used to install some elements. A driving head 14 can be inserted into the inserting end 13 so as to form as a spanner.

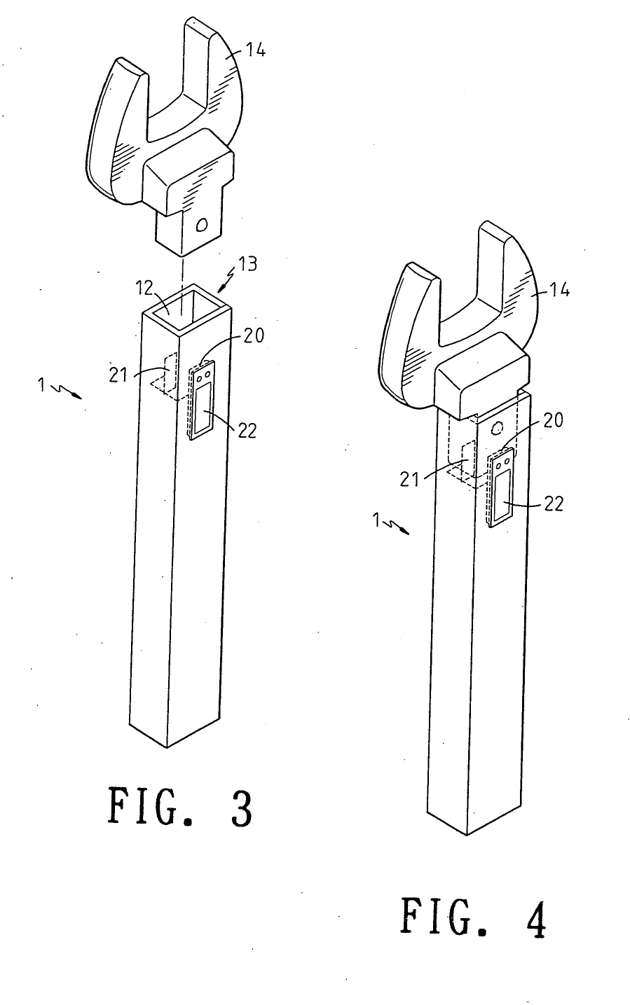

Referring to FIGS. 3 and 4, it is illustrated that a driving head 14 is inserted into the inserting end 13 of the rod body 1. A strain gauge 21 is installed within the receiving space 12 near the inserting end 13. A processing unit 20 is installed in the receiving space 12. A display 22 is protruded from the open hole 11. Thereby the strain force of the driving head 14 can be measured by the strain gauge 21. Then the measured value is transferred to the processing unit 20 and then is displayed on the display 22.

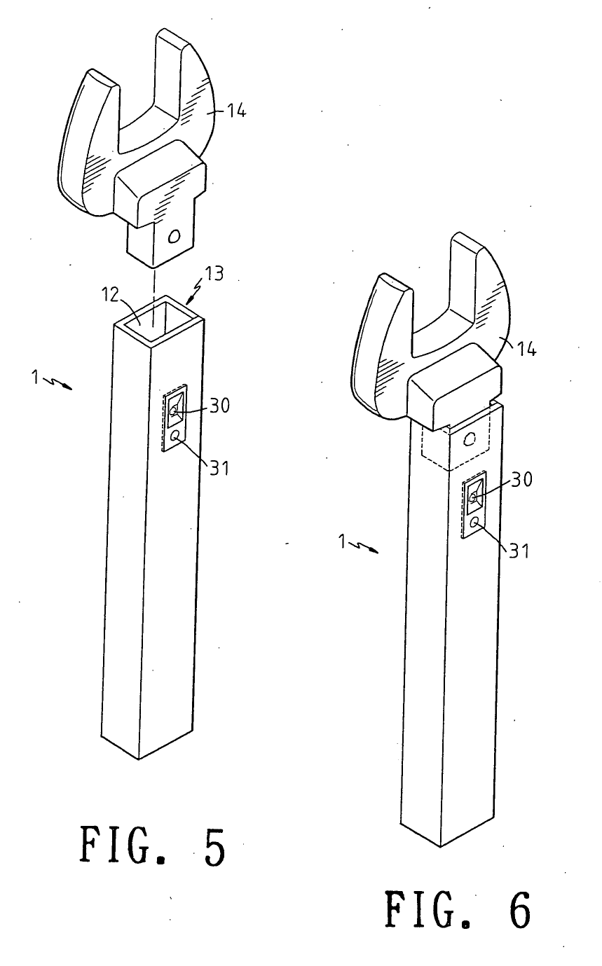

Referring to FIGS. 5 and 6, it is illustrated that a driving head 14 is inserted into the inserting end 13 of the rod body 1. A lamp 30 is installed in the open hole 11 and a switch 31 is installed below the lamp body 30. The lamp body 30 can have a battery (not shown). Thereby The spanner can be worked in a dark area by lighting up the lamp body 30.

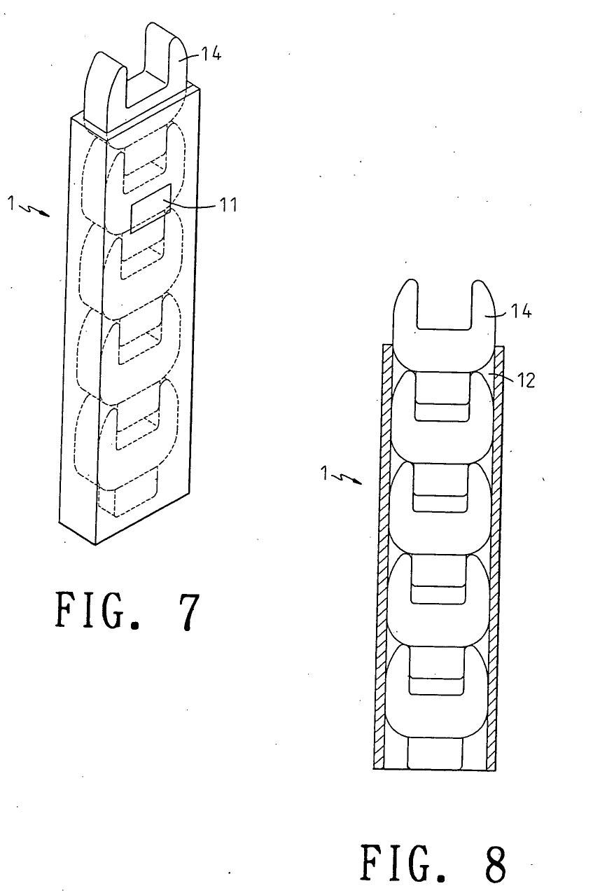

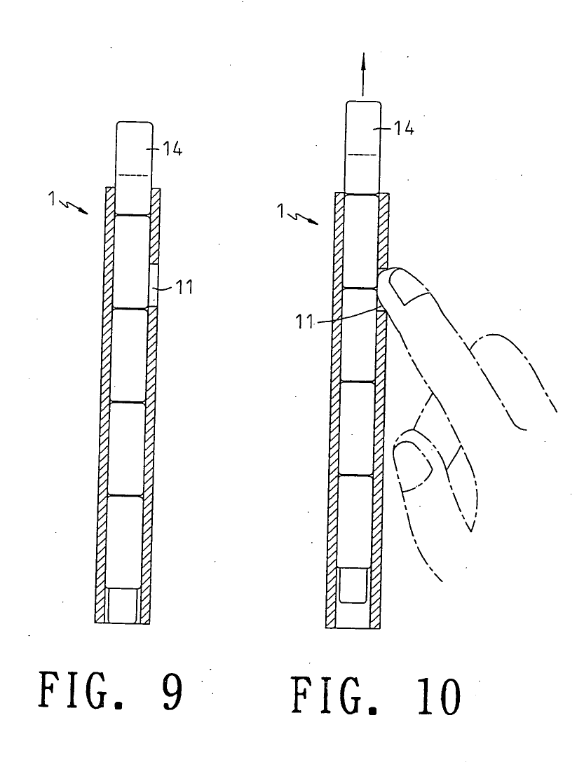

Referring to FIGS. 7 to 10, it is illustrated that a plurality of driving heads 14 are received in the receiving space 12. In operation, a driving head 14 can be taken out by a finger entering into the open hole 11 to move one of the driving head 14 to move out of the rod body 1.

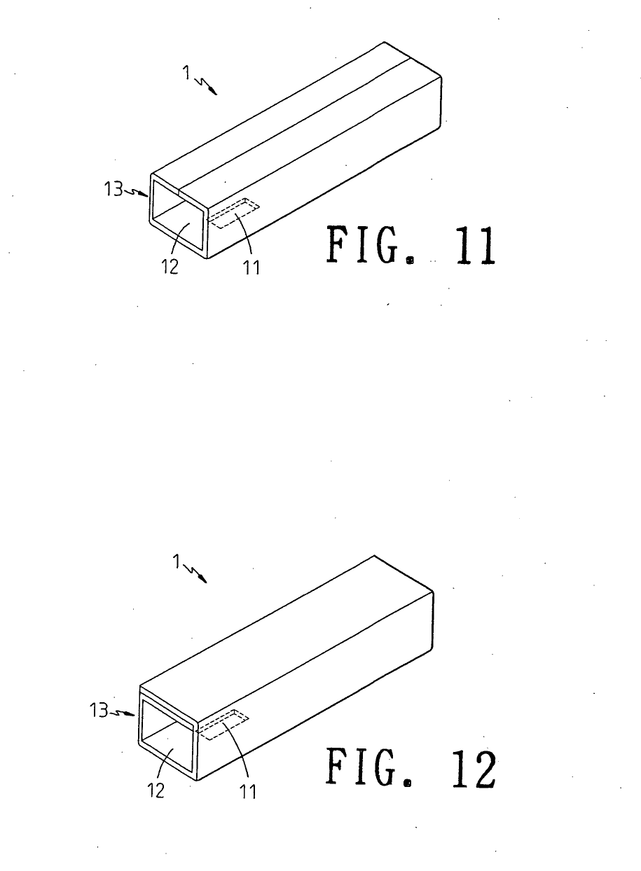

Referring to FIGS. 11 and 12, in FIG. 12, it is illustrated that two layers of the sheet 10 are overlapped at one side of the rod body 1 so as to have a strong strength.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tool hand tube rod comprising:
a long hollow rod body; having a receiving space; a lateral side of the rod body having an open hole; and one end of the rod body having a inserting end.

2. The tool hand tube rod as claimed in claim 1, wherein the rod body is made by punching a metal sheet.

3. The tool hand tube rod as claimed in claim 1, wherein
a driving head inserted into the inserting end of the rod body;
a strain gauge installed within the receiving space near the inserting end;
a processing unit installed in the receiving space;
a display protruded from the open hole; and
wherein a strain force of the driving head can be measured by the strain gauge; then the measured value is transferred to the processing unit and then is displayed on the display.

4. The tool hand tube rod as claimed in claim 1, wherein a lamp is installed in the open hole and a switch is installed below the lamp body.

5. The tool hand tube rod as claimed in claim 1, wherein a plurality of driving heads are received in the receiving space, wherein a user can take out one driving head by inserting a finger into the open hole.

6. A tool hand tube rod comprising:
a long hollow rod body; having a receiving space; a lateral side of the rod body having an open hole; and one end of the rod body having a inserting end;
a driving head inserted into the inserting end of the rod body;
a strain gauge installed within the receiving space near the inserting end;
a processing unit installed in the receiving space;
a display protruded from the open hole; and
wherein a strain force of the driving head can be measured by the strain gauge; then the measured value is transferred to the processing unit and then is displayed on the display.

7. A tool hand tube rod comprising:
a long hollow rod body; having a receiving space; a lateral side of the rod body having an open hole; and one end of the rod body having a inserting end;
a lamp installed in the open hole and
a switch installed below the lamp body.

8. A tool hand tube rod comprising:
a long hollow rod body; having a receiving space; a lateral side of the rod body having an open hole; and one end of the rod body having a inserting end; and
a plurality of driving heads are received in the receiving space.
